(19) United States
(12) Patent Application Publication
(10) Pub. No.: US 2024/0181299 A1
(43) Pub. Date: Jun. 6, 2024

(54) RUBBER COMPOSITION FOR GOLF BALL, AND GOLF BALL

(71) Applicant: BRIDGESTONE SPORTS CO., LTD., Tokyo (JP)

(72) Inventor: Jun SHINDO, Chichibushi (JP)

(73) Assignee: BRIDGESTONE SPORTS CO., LTD., Tokyo (JP)

(21) Appl. No.: 18/509,868

(22) Filed: Nov. 15, 2023

(30) Foreign Application Priority Data
Dec. 6, 2022 (JP) 2022-194635

(51) Int. Cl. A63B 37/00; C08F 36/06; C08K 5/098; C08K 5/42

(52) U.S. Cl. CPC A63B 37/0051; A63B 37/0074; C08F 36/06; C08K 5/098; C08K 5/42; C08F 2810/20

(57) ABSTRACT

The present invention provides a rubber composition for golf balls which includes (a) a base rubber, (b) a co-crosslinking agent being an α,β-unsaturated carboxylic acid and/or a metal salt thereof, (c) a crosslinking initiator and (d) a specific amount of an anionic surfactant, so that the rubber composition reduces sticking of a molded rubber material made therefrom to the mold and also maintains the resilience and other properties of the molded rubber material.

### CROSS-REFERENCE TO RELATED APPLICATIONS

This non-provisional application claims priority under 35 U.S.C. § 119(a) on Patent Application No. 2022-194635 filed in Japan on Dec. 6, 2022, the entire contents of which are hereby incorporated by reference.

### TECHNICAL FIELD

The present invention relates to a rubber composition for a golf ball and to a golf ball in which the rubber composition is used. More particularly, the invention relates to a rubber composition that can be suitably used as a core material in a golf ball having a core of one or more layer and a cover of one or more layer, and relates also to a golf ball in which the rubber composition is used.

### BACKGROUND ART

In order to endow a molded rubber material for a golf ball with both resilience and durability to impact, the desired molded material is generally obtained by charging into a mold and heating a rubber composition composed primarily of polybutadiene rubber. The rubber composition more specifically includes a base rubber composed primarily of polybutadiene rubber and additionally includes an unsaturated carboxylic acid such as acrylic acid or methacrylic acid, or a metal salt thereof, a radical initiator such as an organic peroxide, and also, in cases where an acid such as acrylic acid or methacrylic acid is used, a neutralizing metal source such as zinc oxide. It is known that when such a rubber composition is molded under applied heat, the molded material and the mold stick firmly to each other. Golf ball production operators thus adopt measures to facilitate removal of the molded material from the mold, such as coating the interior of the mold with a fluorocarbon resin or applying a mold parting agent to the mold surfaces each time the mold is used.

However, when a mold parting agent is applied to the mold surfaces at every use, the burden of costs for the mold parting agent adds up and this operation lowers the overall golf ball productivity. As for the approach of coating the mold with a fluorocarbon resin, to maintain the mold parting ability, the fluorocarbon resin-coated mold must be periodically replaced. On top of the cost of such replacement itself, an additional cost associated with this approach is that of preparing a spare mold for use during the replacement operation.

Another approach under investigation is the addition of a mold release agent such as any of various surfactants to the rubber composition, but adding a mold release agent runs the risk of lowering the properties of the molded rubber material. JP-A H09-202747 describes a method for producing finely divided zinc acrylate where, in the presence of an anionic surfactant, acrylic acid and a higher fatty acid are reacted with zinc oxide in an organic solvent while dispersing the zinc oxide in the organic solvent. JP-A H11-9720 describes the use of a mixture of the zinc acrylate of JP-A H09-202747 and a zinc salt of a higher fatty acid in a golf ball core-forming rubber composition. However, although this prior-art literature does mention improvement effects on the dispersibility of zinc acrylate in rubber and its reactivity during vulcanization, and on adhesion to a container and dustability during milling, there is no suggestion whatsoever of mold release-improving effects by anionic surfactants during vulcanization of a rubber composition. Nor is there any mention of a suitable range in the amount of addition for the purpose of mold releasability.

### SUMMARY OF THE INVENTION

It is therefore an object of the present invention to provide a rubber composition for golf balls which is able to reduce sticking of the molded rubber material to the mold and is also able to maintain the resilience and other properties of the molded rubber material. Another object of the invention is to provide a golf ball in which such a rubber composition is used.

As a result of intensive investigations, I have discovered that by having a rubber composition for a golf ball core include as essential ingredients (a) a base rubber, (b) a co-crosslinking agent which is an α,β-unsaturated carboxylic acid and/or a metal salt thereof, (c) a crosslinking initiator and (d) an anionic surfactant, sticking of the molded rubber material to the mold can be reduced without altering to any great degree the physical properties of the molded rubber material. That is, even when a mold coated with a fluorocarbon resin is used, the frequency with which the mold is periodically replaced decreases, making it possible to improve the production efficiency and cut costs and also enabling the resilience and other properties of the resulting molded rubber material to be maintained.

Accordingly, in a first aspect, the invention provides a rubber composition for golf balls which includes (a) a base rubber, (b) a co-crosslinking agent which is an α,β-unsaturated carboxylic acid and/or a metal salt thereof, (c) a crosslinking initiator, and (d) an anionic surfactant. Component (d) is included in an amount of from 0.1 to 12 parts by weight per 100 parts by weight of component (a).

In a preferred embodiment of the rubber composition of the invention, component (d) is included in an amount of from 0.3 to 6 parts by weight per 100 parts by weight of component (a).

In another preferred embodiment of the inventive rubber composition, component (d) is a sulfonic acid-based anionic surfactant. The sulfonic acid-based anionic surfactant is preferably an alkyl benzene sulfonic acid metal salt.

In yet another preferred embodiment, a material molded under heat from the composition is adapted for use as a golf ball core.

In a second aspect, the invention provides a golf ball having a core and a cover of one or more layer encasing the core, wherein the core is formed of the rubber composition according to the first aspect of the invention.

### Advantageous Effects of the Invention

The rubber composition for a golf ball of the invention is able to reduce sticking of a molded rubber material made therefrom to the mold during rubber molding, thereby increasing golf ball productivity. Moreover, there is no decrease in the resilience and other properties of the resulting molded rubber material, enabling the performance attributes of the material to be well maintained.

### DETAILED DESCRIPTION OF THE INVENTION

The objects, features and advantages of the invention will become more apparent from the following detailed description.

The rubber composition for golf ball of the invention is characterized by including components (a) to (d) below:
(a) a base rubber,
(b) a co-crosslinking agent which is an α,β-unsaturated carboxylic acid and/or a metal salt thereof,
(c) a crosslinking initiator, and
(d) an anionic surfactant,
The base rubber serving as component (a) is not particularly limited, although it is especially suitable to use a polybutadiene.

It is desirable for the polybutadiene to have on the polymer chain thereof a cis-1,4 bond content of 60% or more, preferably 80% or more, more preferably 90% or more, and most preferably 95% or more. When cis-1,4 bonds account for too few of the bonds on the polybutadiene molecule, the resilience may decrease.

The content of 1,2-vinyl bonds on the polybutadiene is generally not more than 2%, preferably not more than 1.7%, and more preferably not more than 1.5%, of the polymer chain. When the content of 1,2-vinyl bonds is too high, the resilience may decrease.

The polybutadiene has a Mooney viscosity of preferably at least 20, and more preferably at least 30. The upper limit is preferably not more than 120, more preferably not more than 100, and even more preferably not more than 80.

The term “Mooney viscosity” used herein refers to an industrial indicator of viscosity (JIS K 6300) measured with a Mooney viscometer, which is a type of rotary plastometer. This value is represented by the unit symbol ML₁₊₄ (100° C.), wherein “M” stands for Mooney viscosity, “L” stands for large rotor (L-type) and “1+4” stands for a pre-heating time of 1 minute and a rotor rotation time of 4 minutes. The “100° C.” indicates that measurement was carried out at a temperature of 100° C.

The polybutadiene used may be one synthesized with a lanthanide rare-earth catalyst or a group VIII metal compound catalyst.

A polybutadiene rubber synthesized with a catalyst differing from the above lanthanide rare-earth catalyst may be included in the base rubber. In addition, styrene-butadiene rubber (SBR), natural rubber, polyisoprene rubber, ethylene-propylene-diene rubber (EPDM) or the like may also be included. These may be used singly or two or more may be used in combination.

The polybutadiene accounts for a proportion of the overall rubber that is preferably 60 wt % or more, more preferably 70 wt % or more, and most preferably 90 wt % or more. The above polybutadiene may account for 100 wt % of the base rubber; that is, it may account for all of the base rubber.

Component (b) is a co-crosslinking agent which is an α,β-unsaturated carboxylic acid and/or a metal salt thereof. The number of carbon atoms on this unsaturated carboxylic acid is preferably from 3 to 8. Specific examples include unsaturated carboxylic acids such as acrylic acid, methacrylic acid, maleic acid and fumaric acid. Specific examples of the metal in the metal salts of these unsaturated carboxylic acids include zinc, sodium, magnesium, calcium and aluminum, with zinc being especially preferred. The co-crosslinking agent is most preferably zinc acrylate.

Component (b) is included in an amount per 100 parts by weight of the base rubber serving as component (a) which is preferably at least 10 parts by weight, more preferably at least 15 parts by weight, and even more preferably at least 20 parts by weight. The upper limit is preferably not more than 65 parts by weight, more preferably not more than 60 parts by weight, and even more preferably not more than 55 parts by weight. At a content lower than this range, the ball may be too soft and have a poor rebound. At a content higher than this range, the ball may be too hard, resulting in a poor feel at impact, and may also be brittle and thus have a poor durability.

The co-crosslinking agent serving as component (b) has a mean particle size of preferably from 3 to 30 μm, more preferably from 5 to 25 μm, and even more preferably from 8 to 15 μm. At a mean particle size for the co-crosslinking agent that is below 3 μm, the co-crosslinking agent tends to agglomerate within the rubber composition, leading to a rise in reactivity between molecules of acrylic acid and a decline in reactivity between molecules of the base rubber, as a result of which the golf ball may be unable to achieve a sufficient rebound performance. At a mean particle size for the co-crosslinking agent in excess of 30 μm, the co-crosslinking agent particles become too large, increasing the variability in the properties of the resulting golf ball.

Component (c) is a crosslinking initiator. It is preferable to use an organic peroxide as this crosslinking initiator, and especially preferable to use an organic peroxide having a one minute half-life temperature of between 110 and 185° C. Examples of such organic peroxides include dicumyl peroxide (Percumyl D, from NOF Corporation), 2,5-dimethyl-2.5-di(t-butylperoxy)hexane (Perhexa 25B, from NOF Corporation) and di(2-t-butylperoxyisopropyl)benzene (Perbutyl P, from NOF Corporation). The use of dicumyl peroxide is preferred. Other commercial products include Perhexa C-40, Niper BW and Peroyl L (all from NOF Corporation), and Luperco 231XL (from AtoChem Co.). These may be used singly, or two or more may be used together.

The amount of component (c) included per 100 parts by weight of the base rubber is preferably at least 0.1 part by weight, and more preferably at least 0.3 part by weight. The upper limit is preferably not more than 5 parts by weight, more preferably not more than 4 parts by weight, and even more preferably not more than 3 parts by weight.

Next, component (d) is an anionic surfactant. Anionic surfactants are generally divided broadly into the categories of carboxylic acid-based, sulfonic acid-base, sulfate ester-based and phosphate ester-based compounds. Examples of sulfonic acid-based anionic surfactants include dialkyl sulfosuccinic acids and metal salts thereof, alkane sulfonic acids and metal salts thereof, α-olefin sulfonic acids and metal salts thereof, linear alkyl benzene sulfonic acids and metal salts thereof, branched alkyl benzene sulfonic acids and metal salts thereof, naphthalene sulfonic acid metal salt-formaldehyde condensation products, alkyl naphthalene sulfonic acids and metal salts thereof, and N-methyl-N-acyl taurines and metal salts thereof. Of these, it is especially preferable to use linear alkyl benzene sulfonic acids and metal salts thereof.

The amount of component (d) included per 100 parts by weight of the base rubber is at least 0.1 part by weight, preferably at least 0.3 part by weight, more preferably at least 0.5 part by weight, and even more preferably at least 0.6 part by weight. The upper limit is not more than 12 parts by weight, preferably not more than 10 parts by weight, more preferably not more than 6 parts by weight, and even more preferably not more than 3 parts by weight. When too much component (d) is included, the effect of reducing sticking of the molded rubber material to the mold increases, but rubber properties such as resilience and hardness markedly decrease. When too little component (d) is included, sticking of the molded rubber material to the mold cannot be reduced, leading to a decline in productivity and higher costs.

In addition to above components (a) to (d), various additives such as fillers, antioxidants and organosulfur compounds may be included, provided that doing so does not detract from the advantageous effects of the invention.

Examples of fillers that may be suitably used include zinc oxide, barium sulfate and calcium carbonate. These may be used singly or two or more may be used together. The amount of filler included per 100 parts by weight of the base rubber may be set to preferably at least 1 part by weight, more preferably at least 3 parts by weight, and even more preferably at least 5 parts by weight. The upper limit in the amount of filler included per 100 parts by weight of the base rubber may be set to preferably not more than 100 parts by weight, more preferably not more than 60 parts by weight, and even more preferably not more than 40 parts by weight. When too much or too little filler is included, it may not be possible to obtain a proper weight and a suitable rebound.

Illustrative, non-limiting, examples of antioxidants include phenolic antioxidants such as 2,2-methylenebis(4-methyl-6-tert-butyl phenol), 4,4-butylidenebis(3-methyl-6-tert-butylphenol) and 2,2-methylenebis(4-ethyl-6-tert-butylphenol). Commercial products that may be used include Nocrac NS-6, Nocrac NS-30 and Nocrac NS-5 (all products of Ouchi Shinko Chemical Industry Co., Ltd.). One of these may be used alone or two or more may be used in combination. The antioxidant content per 100 parts by weight of the base rubber, although not particularly limited, is preferably at least 0.05 part by weight, and more preferably at least 0.1 part by weight; the upper limit is preferably not more than 1.0 part by weight, more preferably not more than 0.7 part by weight, and even more preferably not more than 0.4 part by weight. At a content that is too high or too low, a proper core hardness gradient may not be obtainable and it may be impossible to obtain a suitable rebound, a suitable durability, and a suitable spin rate-lowering effect on full shots.

Exemplary organosulfur compounds include, without particular limitation, thiophenols, thionaphthols, diphenylpolysulfides, halogenated thiophenols, and metal salts of these. Specific examples include the zinc salts of pentachlorothiophenol, pentafluorothiophenol, pentabromothiophenol and p-chlorothiophenol, and any of the following having 2 to 4 sulfur atoms: diphenylpolysulfides, dibenzylpolysulfides, dibenzoylpolysulfides, dibenzothiazoylpolysulfides and dithiobenzoylpolysulfides. These may be used singly, or two or more may be used together. Of these, preferred use can be made of the zinc salt of pentachlorothiophenol and/or diphenyldisulfide.

It is recommended that the amount of organosulfur compound included per 100 parts by weight of the base rubber be preferably at least 0.05 part by weight, more preferably at least 0.1 part by weight, and even more preferably at least 0.2 part by weight, and that the upper limit be preferably not more than 3 parts by weight, more preferably not more than 2 parts by weight, and even more preferably not more than 1 part by weight. Including too much organosulfur compound may result in a material molded under heat from the rubber composition having too low a hardness. On the other hand, including too little may make a rebound-improving effect unlikely.

The core can be produced by vulcanizing/curing the rubber composition containing the above ingredients. For example, the core can be produced by using a mixing apparatus such as a Banbury mixer or a roll mill to knead the rubber composition, then using a core mold to compression mold or injection mold the kneaded composition, and suitably heating the molded body at a temperature sufficient for the organic peroxide and the co-crosslinking agent to act, such as at between about 100° C. and about 200° ° C. for a period of 10 to 40 minutes, so as to cure the molded body.

By compounding the ingredients as described above, the molded rubber material for golf balls that has been vulcanized/cured can be provided with a hardness gradient in which the hardness difference between the surface and the center is large. Using this molded rubber material as the golf ball core enables the durability of the golf ball to be increased while maintaining the good spin properties of the ball.

The core (material molded under heat) has a compressive hardness (deformation) when compressed under a final load of 1,275 N (130 kgf) from an initial load state of 98 N (10 kgf) which, although not particularly limited, is preferably at least 2.0 mm, more preferably at least 2.3 mm, and even more preferably at least 2.5 mm. The upper limit is preferably not more than 6.0 mm, more preferably not more than 5.5 mm, and even more preferably not more than 5.0 mm. When this value is too large, the core becomes too soft, as a result of which the resilience may decrease. When this value is too small, a spin rate-lowering effect may not be obtainable and the feel of the ball at impact may become hard.

The core has a diameter which is not particularly limited and depends also on the layer structure of the golf ball to be manufactured. The core diameter is preferably at least 30 mm, and more preferably at least 35 mm, but is preferably not more than 41 mm, and more preferably not more than 40 mm. At a core diameter outside of this range, the initial velocity of the ball may decrease or a suitable spin performance may not be obtained.

It is desirable for the core to have a resilience (core initial velocity) which does not decrease to any great degree compared with a core obtained from a rubber composition formulated without the anionic surfactant serving as component (d) above. Specifically, when the core is fired with an air cannon against a steel plate at 45 m/s, the rebound velocity of the core is measured and the coefficient of restitution, which is the ratio between the core initial velocity and rebound velocity, is determined. It is desirable to produce a rubber composition containing the anionic surfactant serving as component (d) such that a core made therefrom has a coefficient of restitution which, when indexed to a value of 1.000 for the coefficient of restitution of a core made from a rubber composition that does not include the anionic surfactant serving as component (d), differs from the latter by not more than 0.002, and preferably not more than 0.001.

As mentioned above, the foregoing rubber composition is preferably used as a golf ball core. Also, the golf ball of the invention preferably has a construction that includes a core and a cover of one or more layer.

### EXAMPLES

Examples according to the invention and Comparative Examples are given below by way of illustration, although the invention is not limited by the following Examples.

### Examples 1 to 6, Comparative Examples 1 and 2

In each Example, a core is produced by preparing a rubber composition made up primarily of the polybutadiene shown in Table 1 below and carrying out 20 minutes of vulcanization at 155° C. using a hemispherical mold having a diameter of 40.40 mm.

TABLE 1

| | | | | | | | | Comparative | |
|---|---|---|---|---|---|---|---|---|---|
| Rubber compound | | Example | | | | | | Example | |
| (pbw) | | 1 | 2 | 3 | 4 | 5 | 6 | 1 | 2 |
| (a) | Polybutadiene rubber | 100 | 100 | 100 | 100 | 100 | 100 | 100 | 100 |
| — | Zinc oxide | 15.5 | 15.5 | 15.5 | 15.5 | 15.5 | 15.5 | 15.5 | 15.5 |
| — | Organosulfur compound | 0.4 | 0.4 | 0.4 | 0.4 | 0.4 | 0.4 | 0.4 | 0.4 |
| (b) | Zinc acrylate | 37 | 37 | 37 | 37 | 37 | 37 | 37 | 37 |
| — | Antioxidant | 0.1 | 0.1 | 0.1 | 0.1 | 0.1 | 0.1 | 0.1 | 0.1 |
| — | Water | 0.4 | 0.4 | 0.4 | 0.4 | 0.4 | 0.4 | 0.4 | 0.4 |
| (c) | Organic peroxide | 1 | 1 | 1 | 1 | 1 | 1 | 1 | 1 |
| (d) | Sodium dodecylbenzene sulfonate | 0.3 | 0.5 | 1 | 3 | 6 | 12 | 0 | 0 |
| (d′) | Silicone oil | 0 | 0 | 0 | 0 | 0 | 0 | 0 | 1 |

Details on the above ingredients are given below.
Polybutadiene rubber: Available under the trade name “BR700” (ENEOS Corporation, high-cis polybutadiene rubber/Nd catalyst polymerization)
Zinc oxide: Available as “Zinc Oxide Grade 3” (Sakai Chemical Co., Ltd.)
Organosulfur Compound: Zinc salt of pentachlorothiophenol, available from FUJIFILM Wako Pure Chemical Corporation
Zinc acrylate: Available under the trade name “ZN-DA85S” (Nippon Shokubai Co., Ltd.)
Antioxidant: Available under the trade name “Nocrac NS-6” (a hindered phenol antioxidant from Ouchi Shinko Chemical Industry Co., Ltd.)
Water: Distilled water
Organic Peroxide: Dicumyl peroxide, available under the trade name
“Percumyl D” (NOF Corporation; 100% purity)
Sodium Dodecylbenzene Sulfonate: Available from FUJIFILM Wako Pure Chemical Corporation
Silicone oil: Available under the trade name “KF-96” from Shin-Etsu Chemical Co., Ltd.

The compressive deformation (deflection), resilience and mold releasability of the cores obtained in the Examples of the invention and Comparative Examples are evaluated by the following methods. The results are shown in Table 2.

### Compressive Deformation (Deflection) of Core

The compressive deformation of the core in millimeters when compressed at a temperature of 23±1° C. and a rate of 10 mm/s under a final load of 1,275 N (130 kgf) from an initial load state of 98 N (10 kgf) is measured. The average value for ten measured cores is determined.

### Resilience (Coefficient of Restitution)

The core is fired with an air cannon against a steel plate at 45 m/s, the rebound velocity is measured, and the coefficient of restitution of the core is determined. The coefficient of restitution is the ratio between the core initial velocity and the rebound velocity. The results shown in Table 2 are values indexed to a value of 1.000 for the coefficient of restitution of the core in Comparative Example 1.

### Mold Releasability

The rubber composition in each Example is molded under applied heat using an upper and lower pair of hemispherical molds having a diameter of 40.40 mm whose surfaces are coated with Teflon® resin. That is, the rubber composition in each Example is molded into a cylindrical shape as the rubber for evaluation, following which it is placed in the above mold and molded under applied heat at 155° C. for 20 minutes. After molding under applied heat, the mold is opened and the molded rubber material in each Example is removed by hand. Molding under applied heat is repeatedly carried out until the molded rubber material can no longer be removed by hand, and the number of times molding has been carried out up to this point is referred to as the “number of repeated mold releases.” The results shown in Table 2 are values indexed to a value of 1.0 for the number of repeated mold releases in Comparative Example 1.

TABLE 2

| | | | | | | | Comparative | |
|---|---|---|---|---|---|---|---|---|
| | Example | | | | | | Example | |
| | 1 | 2 | 3 | 4 | 5 | 6 | 1 | 2 |
| Deflection (mm) | 3.25 | 3.23 | 3.23 | 3.25 | 3.27 | 2.32 | 3.22 | 3.45 |
| Resilience (indexed) | 1.000 | 1.000 | 1.000 | 0.999 | 0.999 | 0.998 | 1.000 | 0.997 |
| Mold releasability (indexed) | 2.2 | 2.5 | 2.4 | 5.8 | 5.8 | 5.9 | 1.0 | 1.3 |

It is apparent from Table 2 that the molded rubber materials (cores) in Examples 1 to 6 in which sodium dodecylbenzene sulfonate has been added have an improved mold releasability and an increased number of repeated mold releases relative to Comparative Example 1 in which sodium dodecylbenzene sulfonate has not been added. Also, there is substantially no decline in the core properties (deflection and resilience) in Examples 1 to 6.

With regard to Comparative Example 2 in which silicone oil was added as a mold parting agent, the mold releasability is slightly improved over that in Comparative Example 1, but this improvement effect is not large. Also, the changes in the core properties are large.

Japanese Patent Application No. 2022-194635 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A rubber composition for golf balls, comprising:
(a) a base rubber,
(b) a co-crosslinking agent which is an α,β-unsaturated carboxylic acid or a metal salt thereof or both,
(c) a crosslinking initiator, and
(d) an anionic surfactant,
wherein component (d) is included in an amount of from 0.1 to 12 parts by weight per 100 parts by weight of component (a).

2. The rubber composition of claim 1, wherein component (d) is included in an amount of from 0.3 to 6 parts by weight per 100 parts by weight of component (a).

3. The rubber composition of claim 1, wherein component (d) is a sulfonic acid-based anionic surfactant.

4. The rubber composition of claim 3, wherein the sulfonic acid-based anionic surfactant is an alkyl benzene sulfonic acid metal salt.

5. The rubber composition of claim 1, wherein a material molded under heat from the composition is adapted for use as a golf ball core.

6. A golf ball comprising a core and a cover of one or more layer encasing the core, wherein the core is formed of the rubber composition of claim 1.
